(19) United States
(12) Patent Application Publication
(10) Pub. No.: US 2014/0218600 A1
(43) Pub. Date: Aug. 7, 2014

(54) IMAGE DEVICE AND IMAGING METHOD

(71) Applicant: Olympus Imaging Corp., Tokyo (JP)

(72) Inventor: Satoru NAKAMURA, Fujimi-shi (JP)

(73) Assignee: Olympus Imaging Corp., Tokyo (JP)

(21) Appl. No.: 14/174,648

(22) Filed: Feb. 6, 2014

(30) Foreign Application Priority Data
Feb. 7, 2013 (JP) 2013-021998

(51) Int. Cl. H04N 5/232

(52) U.S. Cl. CPC H04N 5/23241
USPC 348/372

(57) ABSTRACT

An imaging device of the present invention operates with supply of power from a main power supply, and comprises an imaging section having an image sensor for forming a subject image and outputting image data, a variable voltage conversion section, supplied with power from the main power supply, for converting to a designated voltage based on control signals, and outputting the designated voltage, a constant voltage section that receives output of the variable voltage conversion section and supplies a constant voltage signal to the image sensor, an input section for setting operating mode of the imaging device, and a control section for obtaining a voltage value input to the constant voltage section in accordance with operating mode that has been set by the input section, and designating an output voltage to the variable voltage conversion section.

Benefit is claimed, under 35 U.S.C. §119, to the filing date of prior Japanese Patent Application No. 2013-021998 filed on Feb. 7, 2013. This application is expressly incorporated herein by reference. The scope of the present invention is not limited to any requirements of the specific embodiments described in the application.

### BACKGROUND OF THE INVENTION

1. Field of the Invention

The present invention relates to an imaging device and an imaging method, and in detail relates to an imaging device and an imaging method for supplying a constant voltage from a main power supply to an imaging section via a power supply section.

2. Description of the Related Art

An image sensor performs photoelectric conversion on an optical image and outputs image signals, but imaging noise occurs in the image accompanying increase in ambient temperature of the image sensor, which degrades image quality. In order to prevent this imaging noise, in Japanese patent laid open number 2006-140733, if a specified temperature is exceeded a power supply is dropped, a specified mode is transitioned to, a CCD clock is dropped, or a cooling device is operated.

### SUMMARY OF THE INVENTION

An object of the present invention is to provide an imaging device and imaging method that prevent image degradation due to noise, and that do not impair usability.

An imaging device of the present invention operates with supply of power from a main power supply, and comprises an imaging section having an image sensor for forming a subject image and outputting image data, a variable voltage conversion section, supplied with power from the main power supply, for converting to a designated voltage based on control signals, and outputting the designated voltage, a constant voltage section that receives output of the variable voltage conversion section and supplies a constant voltage signal to the image sensor, an input section for setting operating mode of the imaging device, and a control section for obtaining a voltage value input to the constant voltage section in accordance with operating mode that has been set by the input section, and designating an output voltage to the variable voltage conversion section.

An imaging method of the present invention, for an imaging device that is operated by supply of power from a main power supply and has an imaging section including an image sensor for forming a subject image and outputting image data, comprises an output step of causing a variable voltage conversion section to convert a power supply from a main power supply to a designated voltage based on control signals, and output the designated voltage, a supply step of receiving output of the variable voltage conversion section and causing a constant voltage section to supply a constant voltage signal to the image sensor, a setting step of causing an input section to set operating mode of the imaging device, and a designating step of calculating a voltage value input to the constant voltage section in accordance with operating mode that has been set by the input section, and designating an output voltage to the variable voltage conversion section.

### BRIEF DESCRIPTION OF THE DRAWINGS

FIG. 1A and FIG. 1B are drawings showing the external appearance of a camera of one embodiment of the present invention, with FIG. 1A being an external perspective view looking from the rear, and FIG. 1B being an external perspective view looking from the front.

FIG. 2 is a block diagram mainly showing the electrical structure of a camera of one embodiment of the present invention.

FIG. 3 is a block diagram showing an ASIC, and its peripheral circuits, of the camera of one embodiment of the present invention.

FIG. 4 is a block diagram showing a power supply section, and its peripheral circuits, of the camera of one embodiment of the present invention.

FIG. 5A-FIG. 5E are graphs showing characteristics of the camera of one embodiment of the present invention, with FIG. 5A being a graph showing variation in imaging noise with respect to image sensor temperature, FIG. 5B being a graph showing a relationship between imaging noise and LDO output noise, FIG. 5C being a graph showing a relationship between LDO input potential difference and LDO output noise, FIG. 5D being a graph showing a relationship between LDO input potential difference and LDO power consumption, and FIG. 5E being a drawing for describing that imaging noise results from addition of noise ascribable to temperature of the image sensor and LDO output noise.

FIG. 6 is a flowchart showing operation of the camera of one embodiment of the present invention.

FIG. 7 is a flowchart showing operation of the camera of one embodiment of the present invention.

FIG. 8 is a flowchart showing operation of the camera of one embodiment of the present invention.

FIG. 9 is a flowchart showing a voltage setting operation at the time of shooting, of the camera of one embodiment of the present invention.

FIG. 10 is a flowchart showing a first modified example of a voltage setting operation at the time of shooting, of the camera of one embodiment of the present invention.

FIG. 11 is a flowchart showing a second modified example of a voltage setting operation at the time of shooting, of the camera of one embodiment of the present invention.

FIG. 12 is a flowchart showing a third modified example of a voltage setting operation at the time of shooting, of the camera of one embodiment of the present invention.

FIG. 13 is a flowchart showing a fourth modified example of a voltage setting operation at the time of shooting, of the camera of one embodiment of the present invention.

### DETAILED DESCRIPTION OF THE PREFERRED EMBODIMENTS

Preferred embodiments using a camera to which the present invention has been applied will be described in the following in accordance with the drawings. The camera of a preferred one embodiment of the present invention is a digital camera. This camera has an imaging section, with a subject image being converted to image data by this imaging section, and the subject image being subjected to live view display on a display section arranged on the rear surface of the camera body based on this converted image data. A photographer determines composition and photo opportunity by looking at the live view display. At the time of a release operation, still picture image data is stored in a storage medium. Image data that has been stored in the storage medium can be played back and displayed on the display section if playback mode is selected.

Also, this camera is operated by supply of power from a main power supply. A constant voltage is supplied to the imaging section from a variable voltage conversion section. This constant voltage is controlled so that predicted noise level of the image sensor and power consumption loss become optimum, in accordance with a noise level predicted based on ambient temperature of the image sensor and dark current, or operating mode, etc.

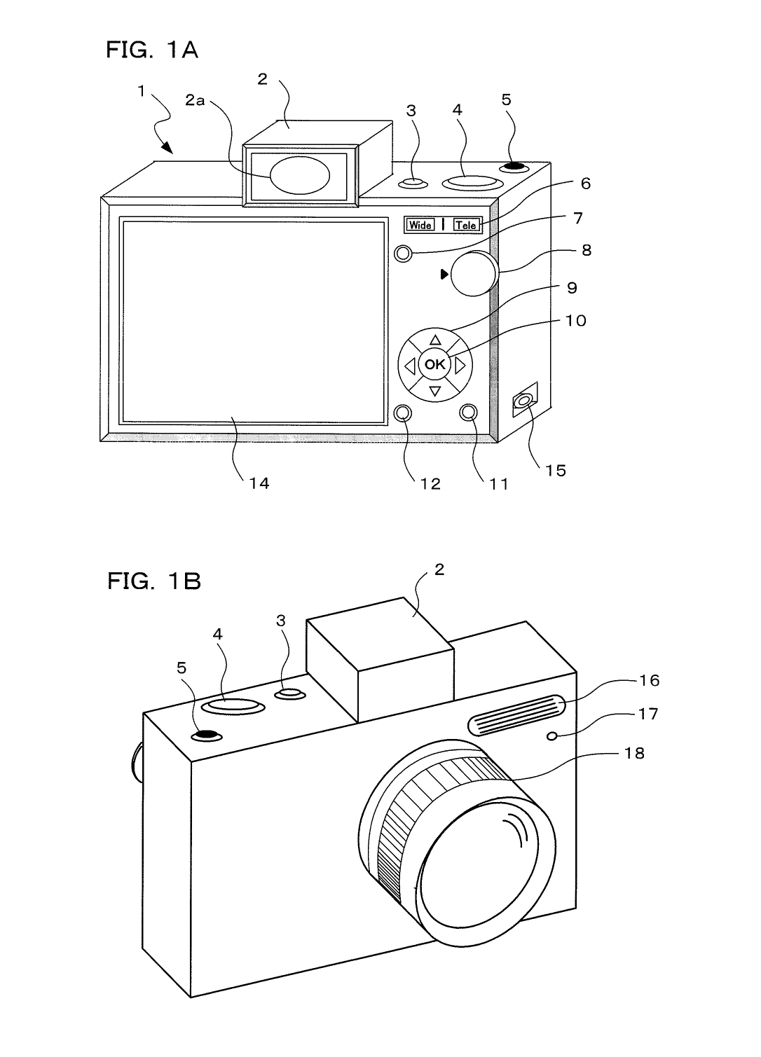

FIG. 1 is drawings showing the external appearance of a camera of one embodiment of the present invention, with FIG. 1A being an external perspective view looking from the rear, and FIG. 1B being an external perspective view looking from the front.

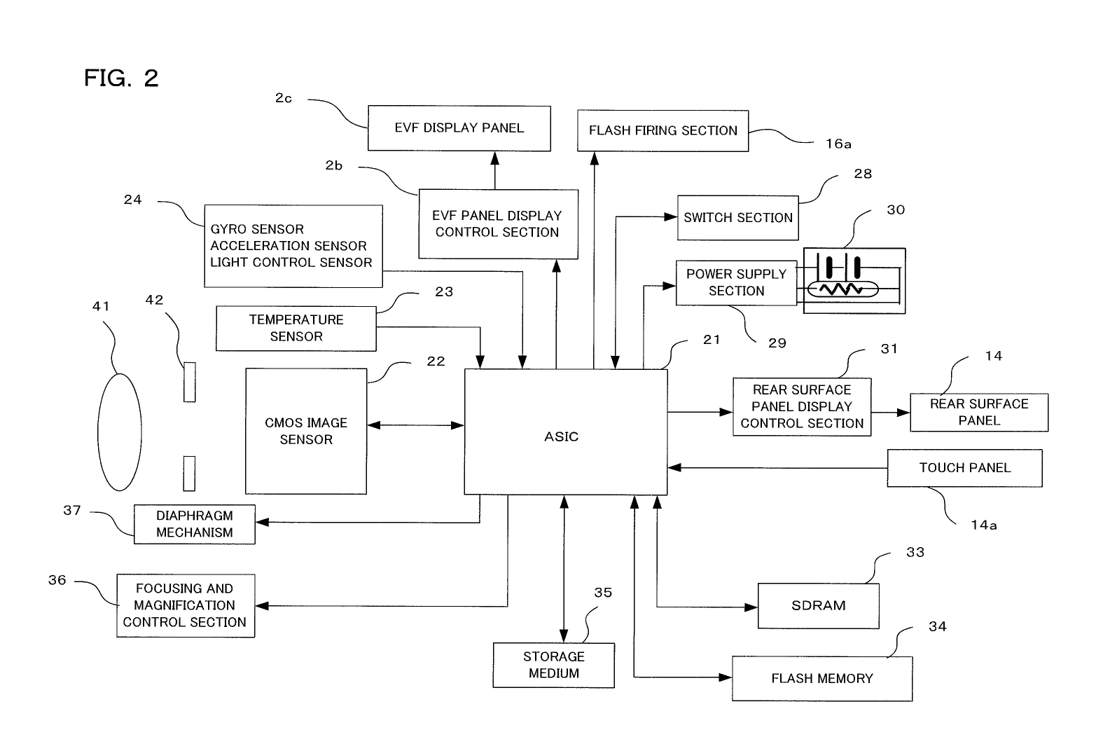

An electronic viewfinder (hereinafter referred to as EVF) 2 is arranged substantially in the center of the camera body 1. The EVF 2 has a small EVF display panel 2c inside (refer to FIG. 2), and the photographer can observe a live view image or a playback image that has been displayed on the EVF display panel 2c by means of a viewfinder eyepiece 2a.

Also, a power supply button 3, a shutter release button 4, and a movie record button 5 are arranged on upper part of the camera body 1. The power supply button 3 is an operation button for putting the camera body 1 into a power on state as a result of the photographer performing a press operation, and putting the camera body 1 into a power off state as a result of performing the press operation again. Instead of the power supply button 3 it is also possible to arrange another operation member such as a power supply switch.

If shutter release button 4 is pressed down half way by the photographer the camera body 1 carries out shooting preparation operations, and if the shutter release button 4 is pressed down fully a shooting operation is instructed. In the shooting preparation state, the camera body 1 measures subject brightness, carries out calculation of exposure control values such as aperture value and shutter speed value, and also carries out automatic focus adjustment (AF). Also, at the time of the shooting operation, exposure control is carried out in accordance with exposure control values that were calculated in the shooting preparation state, and at this time image data for a still image that has been formed by the image sensor is acquired, and the image data is stored in a storage medium 35.

The movie record button 5 is an operation member used by the photographer to designate commencement and completion of movie recording. Specifically, in a state where movie shooting mode has been selected by a mode dial 8, if the movie record button 5 is pressed then movie image data that has been formed by the image sensor is acquired, and storage of image data to the storage medium 35 is commenced. If the movie record button 5 is pressed once again after commencement of storage of the movie, movie recording is terminated. The shutter release button 4 may also serve as the movie record button 5, and in this case commencement and termination of movie shooting may be carried out by operation of the shutter release button 4 after movie recording mode has been set using the mode dial 8 or menu screens.

A zoom button 6, a display switch button 7, the mode dial 8, a cross-shaped button 9, an OK button 10, a delete button 11, and a menu button 12 are arranged on the right side of the rear surface of the camera body 1, with a rear surface panel 14 being arranged on the left side of these operating members.

The zoom button 6 is an operation member for the photographer to adjust focal length of the photographing lens 41 that is provided with an optical zoom function within the lens barrel 18, and has a Wide button and a Tele button. If the Wide button is pressed the focal length of the photographing lens 41 is driven to the wide-angle (short focus) side, while if the Tele button is pressed it is driven to the close-up (long focus) side. Also, if the Wide button is pressed and the lens is stopped at the wide end, and then the Wide button continues to be pressed, a macro mode is switched to. If the tele button continues to be pressed after the lens has reached the tele end, electronic zoom is switched to and the image is further magnified. If electronic zoom is switched to, then differing from the optical zoom that was in use up to that point, zooming is carried out by cropping some of the image data and carrying out enlarged display. With this embodiment, focal length is adjusted using the zoom button, but this is not limiting and it is also possible, for example, to adjust focal length using a rotating member.

The display switch button 7 is an operation member for the photographer to carry out switching as to which of the EVF 2 or the rear surface panel 14 is used as a display unit. Each time this display switch button 7 is pressed, the display alternates between being the EVF 2 or the rear surface panel 14, for display of live view images, playback images or menu screens.

The mode dial 8 is a rotatable operation member, and a mode matching an indicator (a triangular mark in the drawings) is executed. It is possible to set various mode as the mode to be executed, such as, for example, exposure control modes such as shooting mode, playback mode, sports mode, and also art filter mode or movie shooting mode.

The cross-shaped button 9 is an operation member for moving a cursor or the like up, down, left and right, on menu screens etc. and is constituted by 4 buttons for respectively indicating up, down, left and right. An OK button (also called a decision button or confirmation button) 10 is arranged substantially in the middle of these 4 button. This OK button 10 is an operation member for confirming items that have been selected on the menu screens etc. using the cross-shaped button 9.

The delete button 11 is an operation member for deleting selected image data. This deletion is deletion of image data stored in the storage medium 35 if the delete button 11 is pressed after designating an image using the cross-shaped button 9 and the OK button 10.

If the menu button 12 is operated by the photographer, a menu screen is displayed on the rear surface panel 14 or the EVF 2. The photographer can carry out various settings, such as flash firing mode etc., using the menu screens.

The rear surface panel 14 is capable of displaying various images such as a live view image, a play back image or menu screens. Also, a touch panel 14a is provided on this rear surface panel 14, and if the touch panel 14a is touched by the photographer while looking at an image that is displayed on the rear surface panel 14, information relating to this touched position is output. With this embodiment, a liquid crystal display panel is used as the rear surface panel, but this is not limiting and it is also possible to use another display panel such as an organic EL panel etc. Also, the rear surface panel 14 has been arranged on the rear surface of the camera body 1, but this is not limiting, and it is also possible, for example, for the panel to be arranged at another position.

ADC input terminal 15 is provided on a side surface of the camera body 1. The DC input terminal 15 is a terminal for supply of power to the camera body 1 using an external power supply. For example, power may be supplied by converting AC power to DC power, and supplying a DC voltage. This can be used when performing flash photography indoors etc.

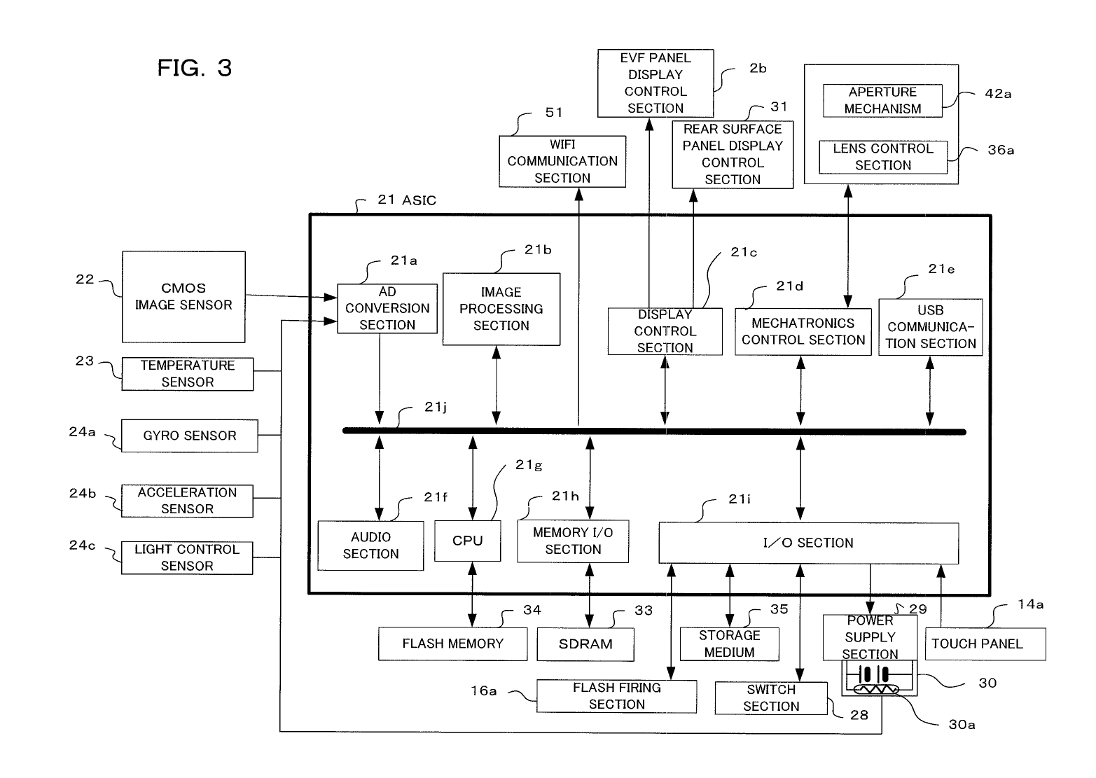

A flash 16, a dimming window 17 and a lens barrel 18 are provided on the front surface of the camera body 1. The flash 16 provides supplementary illumination, and automatically fires when a subject is dark, or is forcibly fired by the photographer etc. The light control window 17 is a window for guiding reflected light etc. to a light control sensor 24c (refer to FIG. 3) for measuring reflected light from a subject etc. at the time of firing the flash 16. In the case of automatically controlling the amount of flashlight at the time of flash firing, control is carried out based on a signal from the light control sensor 24c.

The lens barrel 18 may be an interchangeable lens barrel that can be attached to and removed from the camera body 1, or may be a lens barrel that is fixed to the camera body 1. The photographing lens 41 (refer to FIG. 2), as was described previously, is arranged inside the lens barrel 18.

Next, the electrical structure of this embodiment will be described using FIG. 2. As was described previously, the photographing lens 41 is a variable focal length zoom lens, with a diaphragm 42 being arranged on the optical axis of this photographing lens 41, and a CMOS (Complementary Metal Oxide Semiconductor) image sensor 22 being arranged close to a position where a subject image is formed by the photographing lens 41.

The diaphragm 42 varies an amount of light, of subject light flux that has passed through the photographing lens 41, using a diaphragm mechanism 42a (refer to FIG. 3). Also, a focus lens of the photographing lens 41 is moved in the optical axis direction by a focusing and magnification control section 36 to perform focus, while a zoom lens of the photographing lens 41 is moved in the optical axis direction by the focusing and magnification control section 36 to carry out zooming (magnification).

The CMOS image sensor 22 performs imaging of an optical image that has been formed by the photographing lens 41. This image sensor has photodiodes that constitute each pixel arranged two-dimensionally in a matrix shape, each photodiode generates photoelectric conversion current in accordance with received light amount, and this photoelectric conversion current is the subject of charge storage by a capacitor connected to each photodiode. This stored charge is read out, and output to an A/D conversion section 21a of an ASIC 21 (refer to FIG. 3).

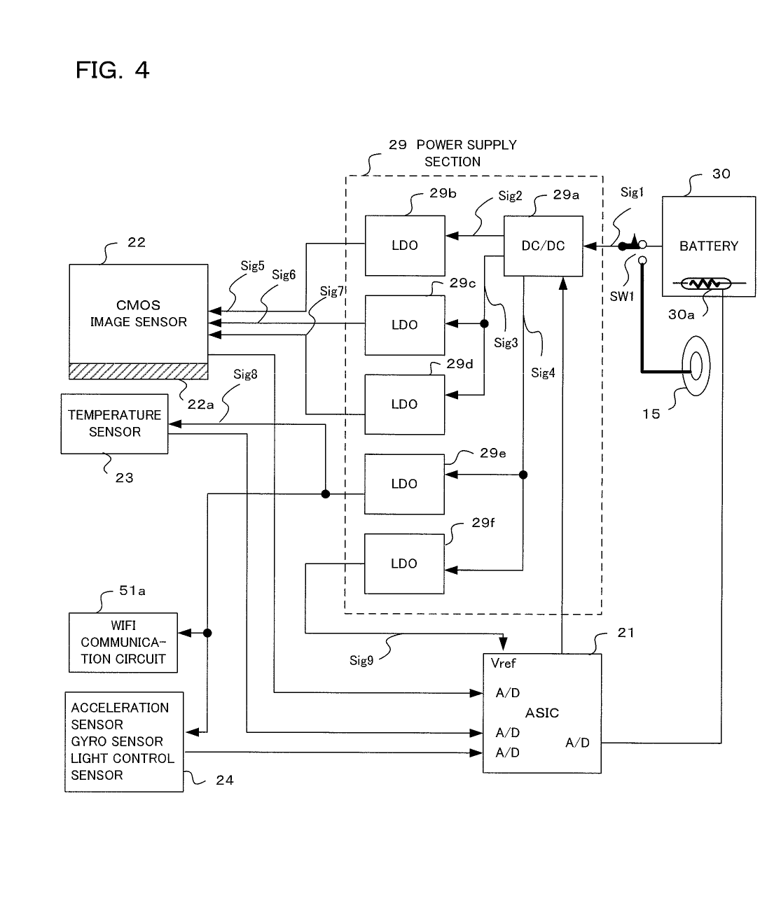

Also, part of an image forming region of the CMOS image sensor 22 has an OB region 22a that is optically shielded (refer to FIG. 4), with signals from this OB region also being output to the A/D conversion section 21a of the ASIC 21, to detect dark current IOB. The CMOS image sensor 22 also has an electronic shutter. The CMOS image sensor 22 and peripheral circuitry functions as an imaging section having an image sensor for forming a subject image and outputting image data.

A temperature sensor 23 is arranged close to the CMOS image sensor 22. This temperature sensor 23 measures the ambient temperature of the CMOS image sensor 22, and outputs a temperature measurement signal to the ASIC 21.

A sensor group 24 is a sensor for measuring vibrations applied to the camera body 1 and flash reflected light. With this embodiment, the sensor group 24 has a gyro sensor 24a, an acceleration sensor 24b and a light control sensor 24c (refer to FIG. 3). The gyro sensor 24a and the acceleration sensor 24b detect vibrations applied to the camera body 1 due to hand shake of the photographer etc., and output detection signals to the ASIC 21. The light control sensor 24c measures reflected light from a main subject at the time of firing the flash 16 by means of the light control window 17, as was described previously, and outputs a photometry signal to the ASIC 21.

An EVF panel display control section 2b is input with image data for display from the ASIC 21, and carries out display control for the EVF display panel 2c. Also, a flash firing section 16a is a firing section of the flash 16, and carries out flash firing in accordance with control signals from the ASIC 21. A switch (SW) section 28 includes various operation members, such as the previously described power supply button 3, shutter release button 4, movie record button 5, zoom button 6, display switch button 7, mode dial 8, cross-shaped button 9, OK button 10, delete button 11, and menu button 12, detects operating states of these operating members, and outputs the detected states to the ASIC 21.

A power supply section 29 is connected to a power supply battery 30, converts a power supply voltage supplied from this power supply battery 30 to a constant voltage, and supplies the constant voltage to each circuit, for example, the ASIC 21, CMOS image sensor 22, temperature sensor 23, sensor group 24 etc. The power supply section 29, power supply battery 30, and their peripheral circuitry, will now be described in detail using FIG. 3.

A rear surface panel display control section 14b is input with image data for display from the ASIC 21, and carries out display control for the rear surface panel 14. Also, a touch panel 14a is provided on the front surface of the rear surface panel 14, and if the photographer touches on the rear surface panel 14 a detection signal relating to this touched position is output to the ASIC 21.

An SDRAM (Synchronous Dynamic Random Access Memory) 33 is connected to the ASIC 21, and temporarily holds data such as image data from the CMOS image sensor 22.

A flash memory 34 is an electrically rewritable nonvolatile memory, and stores programs for operation by a CPU (Central processing unit) 21g (refer to FIG. 3) within the ASIC 21, and various adjustment values.

A storage medium 35 is an electrically rewritable nonvolatile memory that can either be removably installed into the camera body 1 or is fixed within the camera body 1. This storage medium 35 stores image data for a still image or a movie that has been acquired at the time of the shooting operation, and at the time of playback stored image data can be read out.

The ASIC 21 has various circuits, such as the A/D conversion section 21a, an image processing section 21b, a display control section 21c, a mechatronics control section 21d etc., and carries out various processing such as processing of image signals from the CMOS image sensor 22, display processing for the EVF display panel 2c and the rear surface panel 14, and focusing of the photographing lens 41. The ASIC 21 also has a CPU 21g, and carries out overall control of the camera body 1 in accordance with programs stored in the flash memory 34. The programs may also be stored in the storage medium 35 instead of the flash memory 34, and the ASIC 21 may readout and execute programs that are stored in the storage medium 35.

Next, the ASIC 21 and its peripheral circuitry will be described in detail using FIG. 3. For each of the circuits of external sections of the ASIC 21, those shown in FIG. 2 are assigned the same reference numerals and detailed description will be omitted. The gyro sensor 24a, acceleration sensor 24b and light control sensor 24c are sensors within the sensor group 24. Also, a WIFI communication section 51 carries out wireless communication conforming to the WiFi (Wireless Fidelity) standard between the camera body 1 and external devices. A lens control section 36a is provided inside the focusing and magnification control section 36, and carries out drive control for focusing and zooming of the photographing lens 41. The diaphragm mechanism 42a performs drive of the diaphragm 42. A battery temperature sensor 30a is provided inside the power supply battery 30, to measure temperature of the power supply battery 30 and output a temperature measurement signal to the A/D conversion section 21a.

A bus 21j is provided inside the ASIC 21, and the A/D conversion section 21a, image processing section 21b, display control section 21c, mechatronics control section 21d, USB communications section 21e, audio section 21f, CPU 21g, memory I/O 21h and I/O section 21i are connected to this bus 21j. Exchange of various data and control signals is carried out via this bus 21j.

The A/D conversion section 21a is input with analog signals, which are converted to digital data and output to the bus 21j. As input analog signals, there are image signals from the CMOS image sensor 22, a temperature measurement signal of the image sensor from the temperature sensor 23, detection signals from the gyro sensor 24a, the acceleration sensor 24b and the light control sensor 24c, and a temperature measurement signal corresponding to the temperature of the battery from the power supply battery 30.

The image processing section 21b performs various image processing for image data from the CMOS image sensor 22 that has been input via the bus 21j, and outputs the result to the bus 21j. As the various image processing there are image processing for live view display, image processing for storage to the storage medium 35, and image processing for playback of an image that has been read out from the storage medium 35. In the case where art filter mode has been set using the mode dial 8, image processing in accordance with the selected art filter mode is also carried out. Further, the image processing section 21b generates contrast signals in accordance with high-frequency components from image data of the CMOS image sensor 22 for AF control.

The display control section 21c is input with live view images and playback images that have been subjected to image processing by the image processing section 21b, or menu screens, which are then output to the EVF panel display control section 2b and the rear surface panel display control section 14b. Which of these is output is determined in accordance with operating state of the display switch button 7 that has been input by means of the switch section 28 and the I/O section 21i.

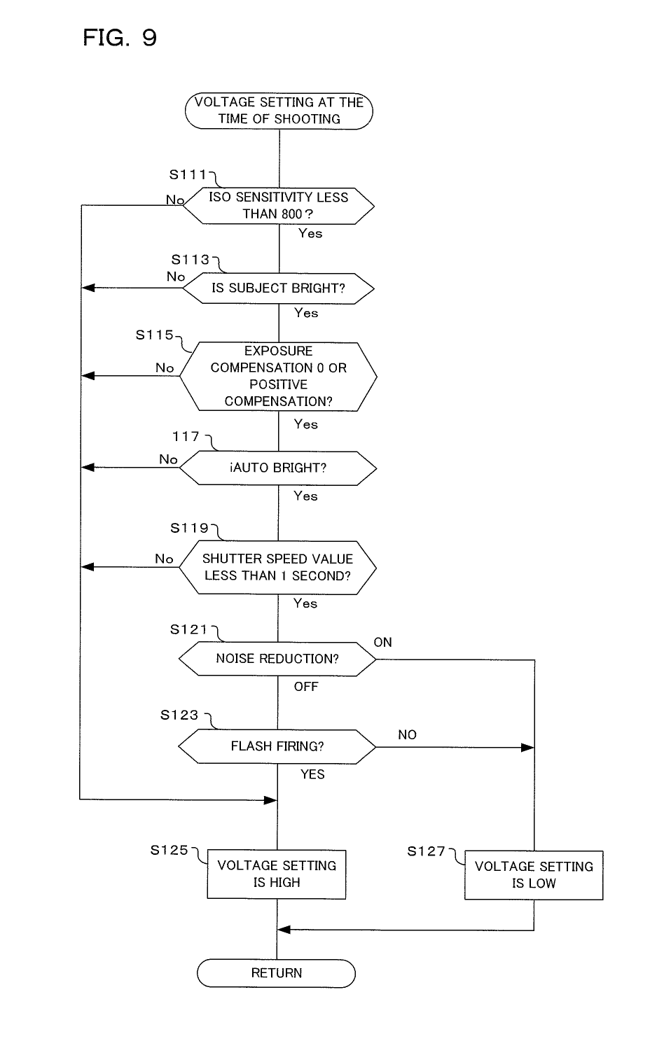

The mechatronics control section 21d performs driver control by means of the lens control section 36a, so that the focusing lens of the photographing lens 41 reaches a focus position, based on the contrast signals that were generated by the image processing section 21b. The mechatronics control section 21d also performs drive control of the zoom lens of the photographing lens 41 using the lens control section 36a, in accordance with operating state of the zoom button 6 that has been input by means of the switch section 28. The mechatronics control section 21d further performs drive control of the aperture mechanism 42 in accordance with exposure control values (including aperture value) that have been calculated by the CPU 21g (refer to S49 in FIG. 9).

The USB communications section 21e performs communication with external devices by means of a USB terminal (not illustrated) provided in the camera body 1. The audio section 21f is input with a voice signal from a microphone (not illustrated), performs voice processing on this voice signal, and stores in the storage medium 35 together with image data for a still image or a movie. The audio section 21f also performs processing of voice signals that have been stored in the storage medium 35 to carry out playback of voice from a speaker (not shown).

The CPU 21g, as was described previously, carries out overall control of the camera body 1 in accordance with programs stored in the flash memory 34.

The memory I/O section 21h is an interface for carrying out reading and writing of data to and from the SDRAM 33. The I/O section 21i is an interface for carrying out read and write of data between each of the circuits within the ASIC 21 and the flash firing section 16a, storage medium 35, switch section 28, power supply section 29, and touch panel 14a, via the bus 21j, or output etc. of control commands.

Next, the power supply section 29 and its peripheral circuitry will be described in detail using FIG. 4. A switch SW1 is arranged between the power supply section 29, power supply battery 30 and DC input terminal 15. Specifically, a fixed terminal is provided on the power supply section 29, while movable terminals are provided on the power supply battery 30 and the DC input terminal 15, and a DC power supply voltage of either the power supply battery 30 or the DC input terminal 15 is supplied to the power supply section 29.

A DC/DC converter 29a and LDO (Low Drop Out) regulators 29b-29f are provided inside the power supply section 29.

The DC/DC converter 29a converts a first dc voltage Sigl that has been provided from the power supply battery 30 or the DC input terminal 15 into second dc voltages Sig2-Sig4, and provides these dc voltages to the LDO regulators 29b-29f. Also, the DC/DC converter 29a is connected to the ASIC 21, and switches between an operating state and a halted state as well as redirecting output of the DC/DC converter 29a in accordance with control commands from the ASIC 21. Specifically, the second dc voltages Sig2-Sig4 are output to one or a plurality of the LDO regulators 29b-29f in accordance with instructions from the ASIC 21.

The second dc voltages Sig2-Sig4 are made differing voltages, but they may also be the same voltage. At least some of the second dc voltages Sig2-Sig4 are voltages appropriate for an operating mode that has been set, and are varied in accordance with instructions from the CPU 21g within the ASIC 21, as will be described later using FIG. 9 to FIG. 14.

The second dc voltage Sig2 is input from the DC/DC converter 29a to the LDO regulator 29b, and the dc voltage Sig5 is output to the CMOS image sensor 22. Also, the second dc voltage Sig3 is input from the DC/DC converter 29a to the LDO regulators 29c and 29d, and the dc voltages Sig6 and Sig7 are output to the CMOS image sensor 22.

The CMOS image sensor 22 is supplied with dc voltage Sig5, dc voltage Sig6 and dc voltage Sig7, and circuits that are supplied with Sig5, among these dc voltages, are more susceptible to the influence of noise compared to those circuits to which Sig6 and Sig7 are supplied.

Also, the LDO regulator 29e is input with second dc voltage Sig4 from the DC/DC converter 29a, and outputs a dc voltage Sig8 to the temperature sensor 23, the WIFI communication section 51a and the sensor group 24. The LDO regulator 29f is also input with the second dc voltage Sig4 from the DC/DC converter 29a, and outputs the dc voltage Sig9 to the ASIC 21.

In this way, the DC/DC converter 29a of this embodiment converts to voltages (dc voltages Sig2-Sig4) that have been designated based on control signals from the CPU 21g within the ASIC 21, and outputs these voltages. Also, the LDO regulators 29b-29f receive outputs of the DC/DC converter 29a, and supply constant voltages to the CMOS image sensor 22.

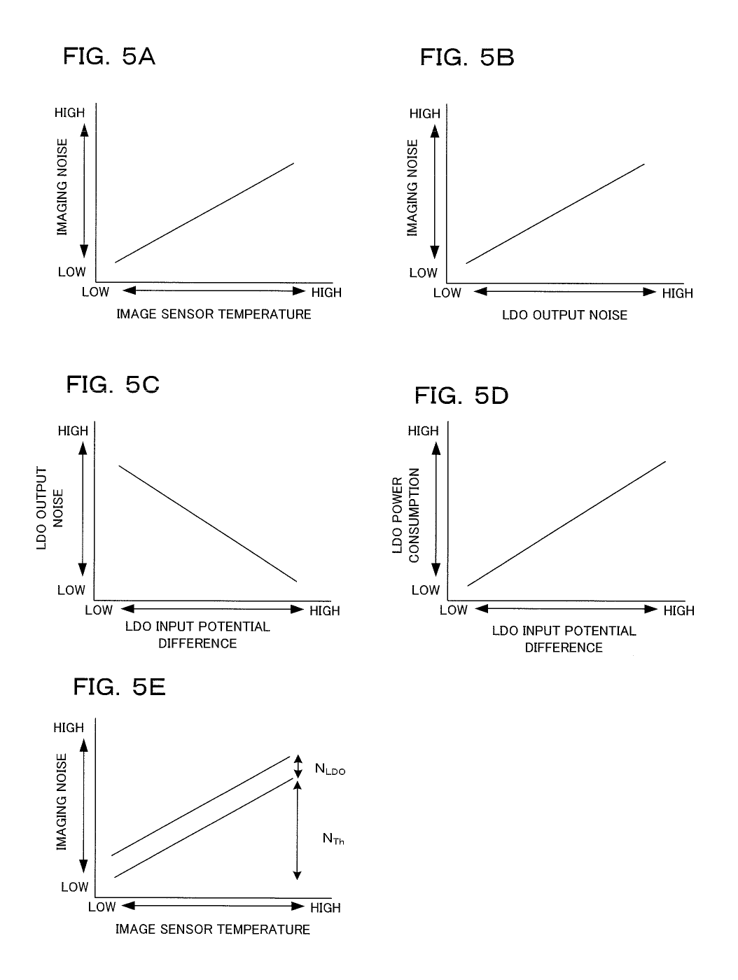

Next, imaging noise etc. of the image sensor (CMOS image sensor 22) will be described using FIG. 5A-FIG. 5E. FIG. 5E is a graph showing a relationship between image sensor temperature and imaging noise. As shown in FIG. 5E, imaging noise is made up of noise N_{Th} that is attributable to temperature of the image sensor 22, and power supply noise N_{LDO} that is attributable to the LDO regulators 29b-29f. FIG. 5A shows variation in imaging noise with respect to temperature of the image sensor. As will be understood from looking at FIG. 5A, imaging noise increases with increase in temperature of the image sensor.

FIG. 5B shows variation in imaging noise with respect to output noise of the LDO regulators 29b-29f. As will be understood from looking at FIG. 5B, imaging noise increases with increase in output noise of the LDO regulators

FIG. 5C shows variation in LDO output noise with respect to input potential difference of the LDO regulators 29b-29f. As will be understood from looking at FIG. 5C, LDO output noise reduces as LDO input potential difference increases.

FIG. 5D shows variation in LDO power consumption with respect to LDO input potential difference of the LDO regulators 29b-29f. As will be understood from looking at FIG. 5D, LDO power consumption also increases as LDO input potential difference increases.

There is thus a tendency for imaging noise to increase if the temperature of the image sensor (CMOS image sensor 22) increases, or if the dark current IOB increases (refer to FIG. 5A). Also, imaging noise increases with increase in LDO output noise (refer to FIG. 5B), and this LDO output noise is reduced if the LDO input potential difference is made larger (refer to FIG. 5C). Accordingly, LDO output noise is reduced by increasing the LDO input potential difference, and as a result the imaging noise is reduced.

In a situation where imaging noise is increased due to a rise in the ambient temperature of the image sensor, it is possible to lower image sensor noise by increasing the LDO input potential difference. To increase the LDO input potential difference, it is preferable to increase the output voltages (Sig2−Sig4) of the DC/DC converter 29a. However, if LDO input potential difference is increased, there will be an increase in LDO power consumption, resulting in power loss, as shown in FIG. 5E.

There will be situations where it is to be expected that imaging noise will be easily noticeable, depending on set values for exposure, such as ISO sensitivity, exposure compensation, shutter speed value etc. Specifically, in cases such as where ISO sensitivity is high, negative exposure compensation is carried out, or there is a long shutter speed etc., it can be considered that this is shooting of a subject in a dark environment, and imaging noise will be easy to notice. Also, in cases such as where noise reduction mode has not been set or a shooting mode such a flash firing mode has not been set, imaging noise will become easily noticeable.

With this embodiment therefore, the DC/DC converter 29a is controlled from the ASIC 21 based on setting values relating to exposure and operating mode, such as shooting mode, so as to give an optimum LDO input potential difference. As a result, imaging noise becomes a specified value or less, and it is also possible to prevent LDO power consumption becoming excessive.

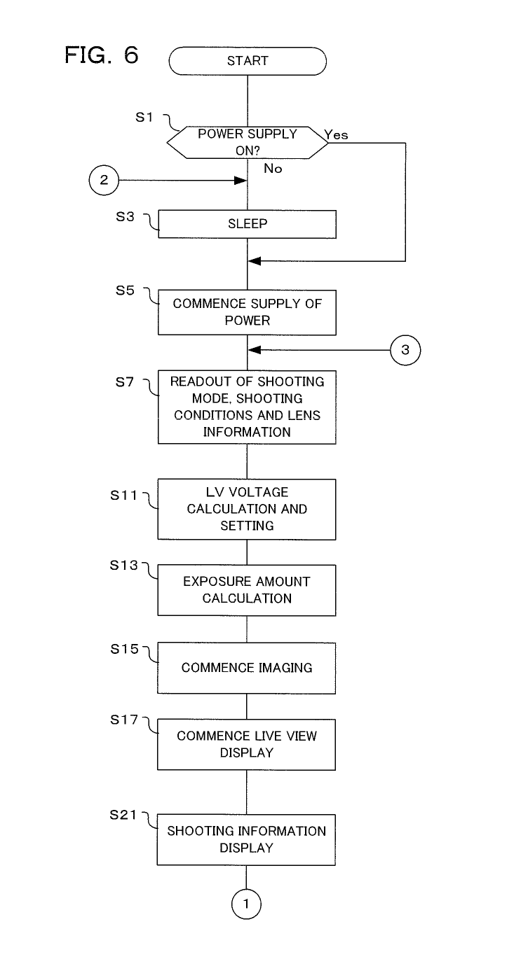

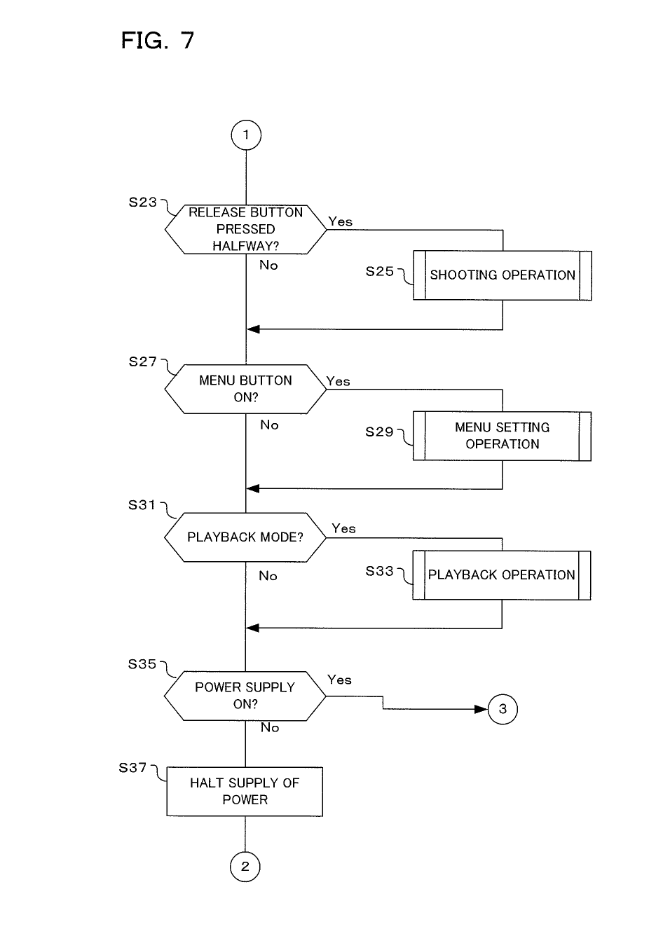

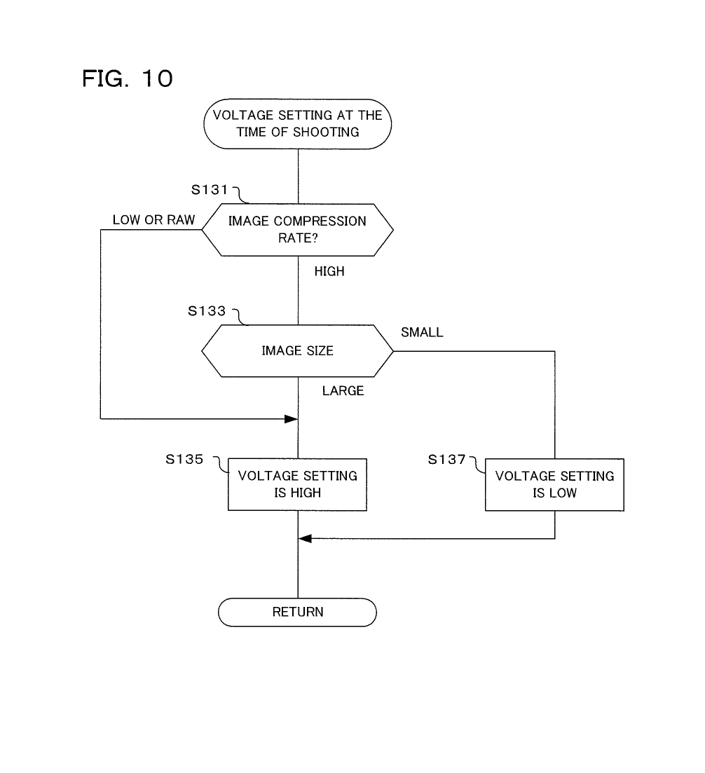

Next, operation of this embodiment will be described using the flowcharts shown in FIG. 6 to FIG. 9. These flowcharts also include the flowcharts shown in FIG. 10 to FIG. 13, which the CPU 21g executes in accordance with programs stored in the flash memory 34.

If the flowchart shown in FIG. 6 is entered, the CPU 21g first determines whether or not the power supply is on (S1). Specifically, operating state of the power supply button 3 is detected by the switch section 28, and determination is based on this detection. If the result of this determination is that the power supply is off, a sleep state is entered (S3). In this sleep state the camera body enters a reduced power consumption mode and only detection of operating state of specified operating members, such as the power supply button 3, is possible, and in the event that a specified operating member, such as the power supply button 3, is operated the sleep state is released.

In the event that the result of determination by the CPU 21g in step S1 was that the power supply was on, or if the sleep state of step S3 is released, supply of power commences (S5). In this step, the power supply section 29 supplies power to each section within the camera body 1.

If the CPU 21g has commenced supply of power, reading out of shooting mode, shooting conditions and lens information is next carried out (S7). In this step, readout is performed for shooting mode that has been set using the mode dial 8, shooting conditions that have been set on menu screens, lens information relating to the photographing lens 41 within the lens barrel 18 etc.

Once the CPU 21g has read out the shooting mode etc. in step S7, live view voltage calculation and setting is next carried out (S11). Here, supply of power is carried out at a predetermined constant voltage from the LDO regulators 29b-29f to the CMOS image sensor 22, being the image sensor, and respective other circuits. It is also possible to vary the constant voltage output from the LDO regulators 29b-29f in accordance with the flowchart shown in FIG. 9, based on the shooting mode and shooting conditions (including setting values related to exposure) that were read out in S7. However, it is also possible to have a constant voltage such that the permitted noise level is higher at the time of live view display than at the time of shooting.

Once the CPU 21g has carried out LV voltage calculation and setting in step S11, exposure calculation is next carried out (S13). In this step, subject brightness is calculated based on image signals from the CMOS image sensor 22, and an electronic shutter speed value etc. that will give optimal brightness when performing live view display is calculated based on this subject brightness.

Once the CPU 21g has carried out exposure calculation, imaging is commenced (S15). In this step, the CMOS image sensor 22 commences imaging, and image signals are read out at time intervals corresponding to a frame rate.

Once the CPU 21g has commenced imaging, live view display is commenced (S17). In this step, a live view image is displayed on the rear surface panel 14 or the EVF 2, on the basis of image signals that have been read out from the CMOS image sensor 22. As will be described later, if the result of determination in step S35 is that the power supply is on, step S7 is returned to and the above-described processing is repeated, to carry out imaging using the CMOS image sensor 22 and update the live view display.

If the CPU 21g has carried out live view display in step S17, shooting information display is next carried out (S21). Here, shooting mode and shooting conditions etc. are displayed on the rear surface monitor 14 or the EVF 2.

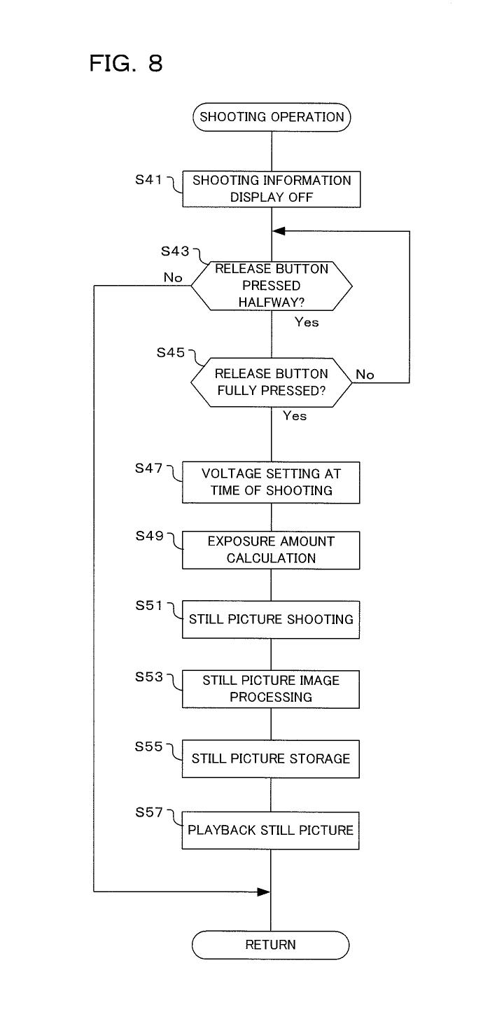

Once the CPU 21g has carried out shooting display, it is next determined whether or not the shutter release button has been pressed down half way (S23). Here it is determined by the switch section 28 whether or not the shutter release button 4 has been pressed down half way. If the result of this determination is that the shutter release button 4 has been pressed down halfway, a shooting operation is carried out (S25). In this step, it is further determined whether or not the shutter release button 4 has been pressed further from half way to being fully pressed, and if it is determined that it is being pressed down fully an image is acquired and stored in the storage medium 35. Detailed operation of this shooting operation will be described later using FIG. 8.

Once the CPU 21g has carried out the shooting operation in step S25, or if the result of determination in step S23 was that the shutter release button 4 was not pressed down half way, it is next determined whether or not the menu button 12 is on (S27). In this step it is determined by the switch section 28 whether or not the menu button 12 has been pressed.

If the result of determination in step S27 is that the menu button is on, the CPU 21g carries out a menu setting operation (S29). In this step, a menu screen is displayed on the rear surface panel 14 or the like, and update to shooting conditions etc. is carried out in response to operation of the cross-shaped button 9, OK button 10 etc.

If the CPU 21g has carried out a menu setting operation in step S29, or if the result of decision in step S27 was that the menu button was not on, it is next determined whether or not the mode dial 8 has been set to playback mode (S31). In this step, the state of the mode dial 8 is detected by the switch section 28, and it is determined whether or not the dial is indicating playback mode.

If the result of determination in step S31 was that the mode dial 8 was set to playback mode, a playback operation is carried out (S33). In this step, image data for an image that has been designated by the user is read out from the storage medium 35, and subjected to playback display on the rear surface panel 14 or the EVF 2.

Once the CPU 21g has carried out a playback operation in step S33, or if the result of determination in step S31 was that the playback button was not on, it is next determined whether or not the power supply is on (S35). In this step it is determined by the switch section 28 whether or not the power supply button 3 is in an on state. If the result of this determination is that the power supply button 3 is in an on state, processing returns to step S7, and the previously described operation is executed.

If the result of determination in step S35 was that the power supply was not on, the CPU 21g stops supply of power (S37). In this step, the power supply section 29 stops the supply of power. Once supply of power has been stopped processing returns to step S3 and a sleep state is entered.

Next, detailed operation of the shooting operation shown in step S25 will be described using FIG. 8. Once the shooting operation is entered, the CPU 21g first turns off the shooting information display (S41). Shooting information is displayed in step S21, but in this step the display of shooting information is removed in order for the photographer to be able to concentrate on a subject during shooting.

Once the CPU 21g has turned off shooting information display, it is next determined whether or not the shutter release button 4 has been pressed down half way (S43). In this step the operating state of the shutter release button 4 is determined by the switch section 28. The fact that the shutter release button 4 has been pressed down half way is detected in step S23, but in this step it is determined whether or not the half pressing of the shutter release button 4 continues. If the result of this determination is that the shutter release button 4 is not being pressed down halfway, the shooting operation flow is terminated and the originating processing flow is returned to.

On the other hand, if the result of determination in step S43 is that the shutter release button has been pressed down half way, it is next determined whether or not the shutter release button has been pressed down fully (S45). Here it is determined by the switch section 28, whether or not the shutter release button 4 has being pressed down further from the half pressed state to enter a fully pressed state. If the result of this determination is that the shutter release button 4 has not been pressed down fully, processing returns to step S43.

On the other hand, if the result of determination in step S45 is that the shutter release button has been pressed down fully, shooting time voltage setting is carried out by the CPU 21g (S47). Here, shooting time voltage setting is carried out in accordance with the shooting mode and shooting conditions that were read out in S7, based on setting value relating to exposure. Specifically, setting values such as ISO sensitivity, subject brightness, exposure compensation value, shutter speed value etc. are determined, and/or it is determined whether noise reduction mode and/or flash firing mode have been set, and an LDO input potential difference that gives a permissible noise level at the time of shooting is obtained, and then setting of the output voltage of the DC/DC converter 29a is carried out so as to give this LDO input potential difference. Detailed operation of this shooting time voltage setting will be described later using FIG. 9.

Once the CPU 21g has carried out shooting time voltage setting, exposure calculation is carried out next (S49). Here, electronic shutter speed value and aperture value etc. to achieve optimal exposure are calculated using subject brightness that was calculated in step S13 (refer to FIG. 6).

Once the CPU 21g has carried out exposure calculation, still picture shooting is carried out next (S51). In this step, exposure control is carried out with a shutter speed value and an aperture value etc., using exposure control values that were calculated in step S49, and once exposure to the CMOS image sensor 22 has been completed image signals for a still picture are read out.

Once the CPU 21g has carried out still picture shooting, next still picture image processing is carried out (S53). In this step, image processing of image signals for a still picture that have been read out from the CMOS image sensor 22 is carried out by the image processing section 21b.

Once the CPU 21g has carried out still picture image processing, still picture storage is next carried out (S55). In this step, image data for a still image that has been subjected to image processing by the image processing section 21b is stored in the storage medium 35. Once still picture storage has been carried out, the still picture is played back (S57). Here, a still picture that was stored in step S55 is displayed on the rear surface panel 14 or the like for a specified time.

Once the CPU 21g has carried out the still picture playback in step S57, or if the result of determination in step S43 was that the shutter release button was not pressed down half way, the originating processing flow is returned to.

In this way, with the camera operation of this embodiment, at the time of a shooting operation input voltage of the LDO regulators is varied by controlling the DC/DC converter 29a in accordance with setting values relating to exposure and operating mode, such as a set shooting mode, so that imaging noise is a permissible level or less (refer to S11 and S47).

To keep imaging noise at a permissible level or lower, in FIG. 5B, LDO output noise that gives a permissible level or lower is obtained, and LDO input potential difference corresponding to this LDO output noise may be obtained from FIG. 5C. In this case, in accordance with exposure setting values and the set shooting mode, it is only necessary to lower the permissible level if the imaging noise is easily noticed, while the permissible level may be increased if the imaging noise is difficult to notice, so as to lower LDO power consumption.

Next, operation of the voltage setting at the time of shooting instep S47 (refer to FIG. 8) will be described using FIG. 9. With this embodiment, an operating mode is set, setting values relating to exposure and the set shooting mode are noted, and input voltage of the LDO regulator is controlled based on these operating modes.

If the flow for voltage setting at the time of shooting shown in FIG. 9 is entered, the CPU 21g first determines whether or not the ISO sensitivity is below ISO 800 (S111). ISO sensitivity is set on a menu screen or the like, or automatically set in accordance with subject brightness. If the result of this determination is that the ISO sensitivity is not less than 800 (ISO sensitivity is greater than or equal to 800), voltage setting is made high (S125). In the case where ISO sensitivity is high, since noise is easy to notice in a subject image, a permissible noise level is made small, and the DC/DC converter 29a is therefore controlled to make input voltage of the LDO regulator high.

If the result of determination in step S111 is that the ISO sensitivity is less than 800, the CPU 21g next determines whether or not shooting subject brightness is bright (S113). Determination here uses the subject brightness that was used at the time of exposure calculation in step S49. If the result of this determination is that the shooting subject is not bright (the shooting subject is dark), voltage setting is made high (S125). In the case where the shooting subject is dark, since noise is easy to notice in a subject image, a permissible noise level is made small, and the DC/DC converter 29a is therefore controlled to make input voltage of the LDO regulator high.

If the result of determination in step S113 is that the shooting subject is bright, the CPU 21g next determines whether or not exposure compensation is 0 or positive compensation (S115). Exposure compensation is set on a menu screen or the like. If the result of this determination is that exposure compensation is not 0 or positive exposure compensation (if negative exposure compensation is to be carried out), voltage setting is made high (S125). In the case of carrying out negative exposure compensation, this is compensation that will tend to darken the screen overall, and since noise is easy to notice in the subject image, a permissible noise level is made small, and the DC/DC converter 29a is therefore controlled to make input voltage of the LDO regulator high.

If the result of determination in step S115 was that exposure compensation is 0 or positive compensation, the CPU 21g next determines whether or not the subject is bright with iAuto (S117). iAuto is a type of shooting mode, and optimum exposure is automatically performed for a shot scene. In this step, it is determined whether or not shooting mode is set to iAuto, and that the shooting subject is bright. If the result of this determination is that it is iAuto and the shooting subject is not bright, voltage setting is made high (S125). In the case where iAuto is set and the shooting subject is dark, since noise is easy to notice in a subject image, a permissible noise level is made small, and the DC/DC converter 29a is therefore controlled to make input voltage of the LDO regulator high.

If the result of determination in step S117 is that iAuto is set and the subject is bright, the CPU 21g next determines whether or not shutter speed is less than one second (S119). A shutter speed value is calculated in step S13. If the result of this determination is that the shutter speed value is not less than one second (shutter speed is slower than one second), voltage setting is made high (S125). In the case where the shutter speed value is slow, since noise is easy to notice in a subject image, a permissible noise level is made small, and the DC/DC converter 29a is therefore controlled to make input voltage of the LDO regulator high.

If the result of determination in step S119 is that the shutter speed value is less than one second, the CPU 21g next determines whether or not noise reduction has been set (S121). Noise reduction is a mode for generating an image from which the effects of noise have been removed, by light shielding the image sensor using a mechanical shutter after shooting has been carried out and a first image signal, has been read out, carrying out imaging with the image sensor shielded and reading out a second image signal, and then subtracting the second image signal from the first image signal. Noise reduction mode is set on a menu screen or the like.

If the result of determination in step S119 is that noise reduction is off, the CPU 21g next determines whether or not flash firing will be carried out (S123). Firing mode of the flash 16 can be set using the mode dial 8 or a menu screen, and the flash 16 fires either if the subject is dark or if manually set to fire. Regarding whether the flash fires or does not fire, this is determined automatically from subject brightness information in the case where flash mode is set to auto, while if the user has set to manual it is determined in accordance with whether the user has set to manual disable flash or set to forcibly fire the flash.

In the case where the result of determination in step S121 is that noise reduction is off, and the result of determination in step S123 is that flash firing is ON, voltage setting is made high (S125). In the case of the subject that requires flash firing, it is dark, and noise reduction will not be carried out, and so it is easy to notice noise in a subject image. Therefore, in order to make a permissible noise level small, the DC/DC converter 29a is controlled to make input voltage of the LDO regulator high.

On the other hand, in the case where the result of determination in step S121 is that noise reduction is on, and the result of determination in step S123 is that the flash will not be fired, voltage setting is made low (S127). In this case, the subject is bright and noise will be difficult to notice in the subject image. Since there is no practical problem even if the permissible noise level is made high, the DC/DC converter 29a is controlled to make input voltage of the LDO regulator low, and power consumption loss is reduced.

Once the CPU 21g has carried out setting of the input voltage of the LDO regulator in step S125 or S127, the originating processing flow is returned to.

In this way, with the voltage setting at the time of shooting of this embodiment, the input voltage of the LDO regulator is controlled based on shooting conditions such as ISO sensitivity and subject brightness, and shooting mode such as noise reduction mode and flash mode. With this embodiment, in the case of settings that may increase imaging noise of the image sensor (CMOS image sensor 22), the DC/DC converter 29a is controlled to make input voltage of the LDO regulator high, so that imaging noise is less noticeable. On the other hand, in the case of shooting conditions and shooting mode that will not increase imaging noise of the image sensor, the LDO regulator input voltage is made low and power consumption loss is minimized.

With this embodiment, ISO for the purposes of determination in step S111 is set to 800, and the shutter speed value is set to one second for the purpose of determination in step S119, but this is only an example, and they may be set to appropriate values accordingly in relation to imaging noise of the image sensor. Also, ISO sensitivity, subject brightness and exposure compensation etc. have been used as shooting conditions, but it is not necessary to determine all of these, and it is also possible to add other shooting conditions. Also, noise reduction mode is used as a shooting mode in this embodiment, but it is not necessary to determine whether the mode is ON or OFF, and it is also possible to add other shooting modes.

Next, a first modified example of the voltage setting at the time of shooting in step S47 (refer to FIG. 8) will be described using FIG. 10. With this modified example, an operating mode is set, shooting conditions setting related to image storage after shooting, namely image compression rate and image size etc., are noted, and input voltage of the LDO regulator is controlled based on these shooting conditions.

If the flow for voltage setting at the time of shooting shown in FIG. 10 is entered, the CPU 21g first determines whether image compression rate is higher or lower than a specified image compression rate, or if RAW data is used (S131). Since image compression rate etc. is set on a menu screen, in this step determination is based on this setting.

If the result of determination in step S131 is that image compression rate is high, the CPU 21g determines whether image size is larger or smaller than a specified size (S133). Since image size is set on a menu screen, in this step determination is based on this setting.

If the result of determination in step S131 is that image compression rate is low, or that RAW data is used, or if the result of determination in step S133 is that image size is large, voltage setting is made high (S135). In cases where the image compression rate is low, RAW data is used, or image size is large, since noise is easy to notice in a subject image, a permissible noise level is made small, and the DC/DC converter 29a is therefore controlled to make input voltage of the LDO regulator high.

On the other hand, if the result of determination in step S133 is that image size is small, the CPU 21g makes the voltage setting low (S137). In this case, since image compression rate is high and image size is small, it is difficult to notice noise in the subject image. Since there is no practical problem even if the permissible noise level is made high, the DC/DC converter 29a is controlled to make input voltage of the LDO regulator low, and power consumption loss is reduced.

Once the CPU 21g has carried out setting of the input voltage of the LDO regulator in step S135 or S137, the originating processing flow is returned to.

In this way, with the voltage setting at the time of shooting of this modified example also, the input voltage of the LDO regulator is controlled based on values relating to image storage after shooting, such as image compression rate and image size. With this modified example also, in the case of settings that will increase imaging noise of the image sensor (CMOS image sensor 22), the DC/DC converter 29a is controlled to make input voltage of the LDO regulator high, so that imaging noise is less noticeable. On the other hand, in the case where there are not shooting conditions that will increase imaging noise of the image sensor, the LDO regulator input voltage is made low and power consumption loss is minimized.

The image compression rate for the purpose of detection in step S131 and the image size for the purpose of detection and step S133 may be values for an extent at which imaging noise of the image sensor (CMOS image sensor 22) is noticeable. Also, image compression rate, RAW data and image size have been used as setting values relating to image storage after shooting, but it is not necessary to determine all of these and it is also possible to add other settings relating to image storage after shooting, or to omit some of these settings.

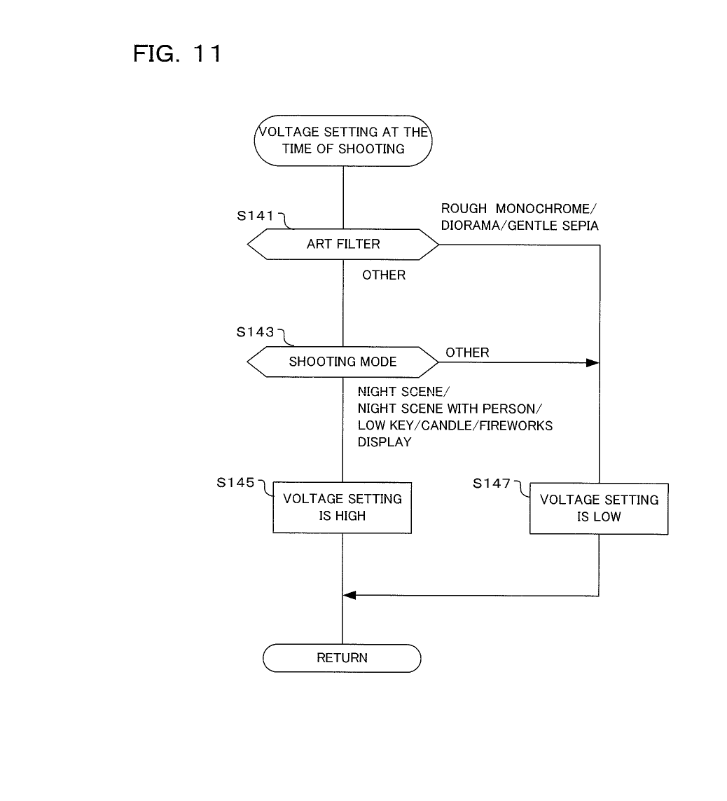

Next, a second modified example of the voltage setting at the time of shooting in step S47 (refer to FIG. 8) will be described using FIG. 11. With this modified example, an operating mode is set, special effect processing (art filter mode) and shooting mode are noted, and input voltage of the LDO regulator is controlled based on this operating mode.

If the flow for voltage setting at the time of shooting shown in FIG. 11 is entered, the CPU 21g first determines the type of art filter (S141). Here, since art filter mode is set on a menu screen etc, in this step determination is in response to this setting. It is determined whether the art filter mode is other than rough monochrome, Diorama or gentle sepia. Rough monochrome is processing to superimpose a previously created noise pattern on the subject image. Diorama carries out gradual blurring processing in accordance with distance from the center, with an AF target of the original image as the center. Gentle sepia carries out processing to blur the entire image with a sepia tone. These three types of art filter superimpose noise or carry out blurring processing, and therefore have a characteristic that imaging noise is less noticeable.

If the result of determination in step S141 was not one of the above three types of art filter mode, the CPU 21g next determines whether the shooting mode is either of a night scene, night scene with person, low key, candle, or fireworks display shooting mode, or whether it is other than one of these shooting modes (S143). Either of these shooting modes is suitable for shooting a dark subject. Low key is a shooting mode that gives a somber mood without losing the gradation of dark portions.

If the result of determination in step S143 was that the shooting mode was one of the above 5 types, such as night scene, voltage setting is made high (S145). In a case where processing that makes imaging noise less noticeable is not carried out as a characteristic of the art filter mode, or in a case of a shooting mode that shoots a dark subject (or a case of processing to darken a subject) since noise is easy to notice in a subject image, a permissible noise level is made small, and the DC/DC converter 29a is therefore controlled to make input voltage of the LDO regulator high.

On the other hand, if the result of determination instep S141 is that one of the above described three types of art filter mode, such as rough monochrome, has been set, or if the result of determination in step S143 is that another shooting mode has been set, the CPU 21g makes the voltage setting low (S147). In this case, since an art filter that makes imaging noise less noticeable, such as rough monochrome, is set, or another shooting mode is set which is not intended for a particularly dark subject, it is difficult to notice noise in the subject image. Since there is no practical problem even if the permissible noise level is made high, the DC/DC converter 29a is controlled to make input voltage of the LDO regulator low, and power consumption loss is reduced.

Once the CPU 21g has carried out setting of the input voltage of the LDO regulator in step S145 or S147, the originating processing flow is returned to.

In this way, with the voltage setting at the time of shooting of this modified example also, the CPU 21g controls the input voltage of the LDO regulator based on special effect processing (art filter mode) and an operating mode, such as shooting mode. With this modified example also, in the case of operating modes that will increase imaging noise of the image sensor (CMOS image sensor 22), the DC/DC converter 29a is controlled to make input voltage of the LDO regulator high, so that imaging noise is less noticeable. On the other hand, in the case where there are not shooting conditions that will increase imaging noise of the image sensor, the LDO regulator input voltage is made low and power consumption loss is minimized.

The art filter mode of step S131 is not limited to the three types, such as rough monochrome, and similarly the shooting mode of step S143 is not limited to the five types, such as night scene mode. Any shooting mode may be applied as long as imaging noise of the image sensor (CMOS image sensor 22) can be made less noticeable by image processing. As a special effect that makes the imaging noise of the image sensor less noticeable as a result of picture image processing, there is, for example, black-and-white processing, sepia tone processing, Diorama processing etc. It is also possible to add other operating modes to these operating modes, or to omit some of the operating modes.

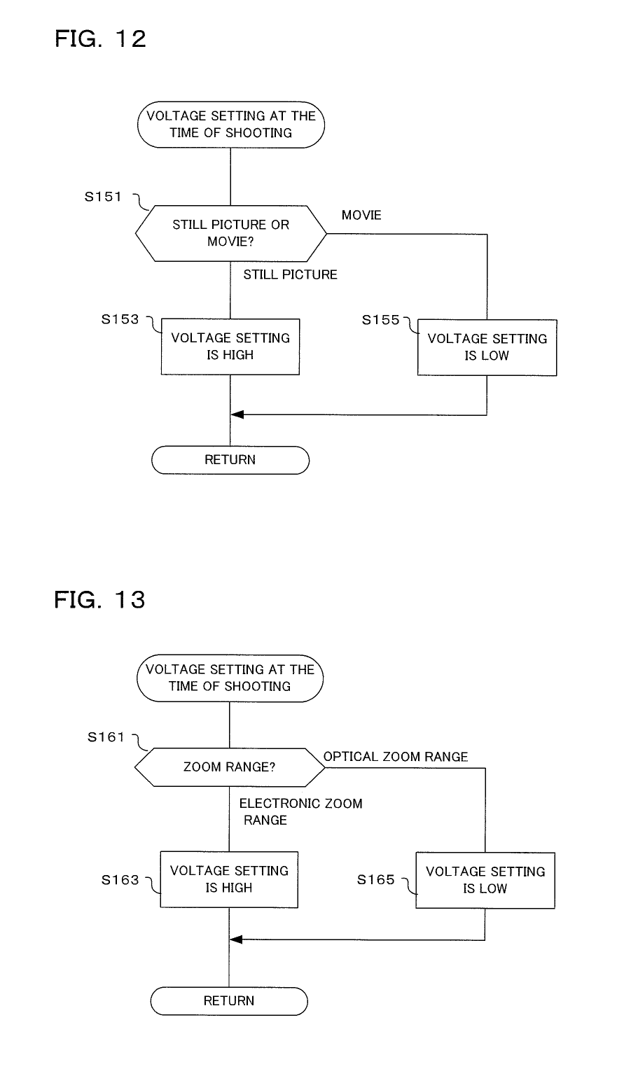

Next, a third modified example of the voltage setting at the time of shooting in step S47 (refer to FIG. 8) will be described using FIG. 12. With this modified example, an operating mode is set, an image storage format is noted, and input voltage of the LDO regulator is controlled in accordance with still image or movie.

If the flow for voltage setting at the time of shooting shown in FIG. 12 is entered, the CPU 21g determines whether it is a still picture or movie (S151). Normally still picture mode is set, or movie mode is set using the mode dial 8, and in this state movie mode is switched to if the movie record button 5 is pressed. In this step determination is made based on the operational state of the mode dial 8 and the movie record button 5.

If the result of determination in step S151 was that still picture was set, the CPU 21g makes the voltage setting high (S153). In the case of still picture, since noise is easy to notice in a subject image, a permissible noise level is made small, and the DC/DC converter 29a is therefore controlled to make input voltage of the LDO regulator high.

On the other hand if the result of determination in step S151 was that movie was set, the CPU 21g makes the voltage setting low (S155). Compared to a still picture, with a movie noise will be difficult to notice in the subject image. Since there is no practical problem even if the permissible noise level is made high, the DC/DC converter 29a is controlled to make input voltage of the LDO regulator low, and power consumption loss is reduced.

In this way, with the voltage setting at the time of shooting of this modified example also, the CPU 21g controls the input voltage of the LDO regulator based on an operating mode, such as still picture or movie shooting mode. With this modified example also, in the case of an image storage format that will increase imaging noise of the image sensor (CMOS image sensor 22), the DC/DC converter 29a is controlled to make input voltage of the LDO regulator high, so that imaging noise is less noticeable. On the other hand, in the case where there is not an image storage format that will increase imaging noise of the image sensor, the LDO regulator input voltage is made low and power consumption loss is minimized.

Next, a fourth modified example of the voltage setting at the time of shooting in step S47 (refer to FIG. 8) will be described using FIG. 13. With this modified example, an operating mode is set, a zoom range is noted, and input voltage of the LDO regulator is controlled in accordance with whether the zoom range is an optical zoom range or an electronic zoom range.

If the flow for voltage setting at the time of shooting shown in FIG. 13 is entered, the CPU 21g first determines whether a zoom range is an optical zoom range or an electronic zoom range (S161). If the tele button within the zoom button 6 is pressed, and continues to be pressed after stopping at the tele end, electronic zoom is switched to. In this step determination is in accordance with the zooming range that has been set using the zoom button 6

If the result of determination in step S161 was the electronic zoom range, voltage setting is made high (S163). In the case of the electronic zoom range, since trimming of image data is carried out noise will be easily noticeable in a subject image compared to the case of an optical zoom. Therefore, a permissible noise level is made small, and in order to do that the DC/DC converter 29a is controlled to make input voltage of the LDO regulator high.

On the other hand if the result of determination in step S161 was the optical zoom range, the CPU 21g makes the voltage setting low (S165). With the optical zoom range noise will be difficult to notice in a subject image compared to the electronic zoom range. Since there is no practical problem even if the permissible noise level is made high, the DC/DC converter 29a is controlled to make input voltage of the LDO regulator low, and power consumption loss is reduced.

In this way, with the voltage setting at the time of shooting of this modified example also, input voltage of the LDO regulator is controlled in accordance with whether the zoom range is an optical zoom range or an electronic zoom range. With this modified example also, in the case of operating modes that will increase imaging noise of the image sensor (CMOS image sensor 22), the DC/DC converter 29a is controlled to make input voltage of the LDO regulator high, so that imaging noise is less noticeable. On the other hand, in the case where there are not operating modes that will increase imaging noise of the image sensor, the LDO regulator input voltage is made low and power consumption loss is minimized.

As has been described above, with the voltage setting at the time of shooting in the one embodiment and each of the modified examples of the present invention, input voltage of the LDO regulator is controlled based on operating modes such as ISO sensitivity, subject brightness, image compression rate, image size, art filter mode, shooting mode, still picture or movie, optical zoom range or electronics zoom range etc. It is therefore possible to optimize imaging noise of the image sensor and power consumption loss of the LDO regulator.

In the operation of voltage setting at the time of shooting that has been described using the flowcharts of FIG. 9 to FIG. 13, respective similar operating modes were determined. However, this is not limiting, and it is also possible to carryout voltage setting for the LDO regulator with combinations of various operating modes. Also, voltage setting of the LDO regulator has been described with two voltages, namely a high voltage and a low voltage, but this is not limiting, and various determination levels may be provided so as to enable voltage setting with three or more voltages,

Also, the flowcharts of FIG. 9 to FIG. 13 are applied to operation for the voltage setting at the time of shooting in step S47 (refer to FIG. 8), but they can also be applied to the LV voltage calculation and setting of step S11 (refer to FIG. 6). In this case, a less stringent level L2 is set as the permitted noise level, and the input voltage of the LDO regulator 29b is set in accordance with this. Compared to the requirements for noise level of a stored image, noise level for a live view image is not so stringent, and power consumption loss is made small.

As has been described above, with the one embodiment and each of the modified examples of the present invention, there are provided a variable voltage conversion section (for example, DC/DC converter 29a) that is supplied with power from a main power supply (for example, power supply battery 30), converts to a designated voltage based on control signals and outputs the converted voltage, a constant voltage section (for example, LDO regulator 29b) that receives output of the variable voltage conversion section and supplies a single constant voltage signal to the image sensor, and an input section (for example, mode dial 8 etc.) for setting operating mode of the imaging device, wherein a voltage value input to the constant voltage section is calculated in accordance with the operating mode that has been set by the input section, and an output voltage to the variable voltage conversion section is designated (for example, S47 in FIG. 8, and the flowcharts of FIG. 9-FIG. 13). It is therefore possible to prevent degradation in image quality due to noise. Also, there are no constraints on shooting, such as transitioning to a specified mode in order to vary a constant voltage supplied to the image sensor in accordance with noise level, or lowering a CCD clock, etc., and so usability is not impaired.

Also, with the one embodiment and each of the modified examples of the present invention, operating mode is a setting relating to exposure at the time of shooting (refer to FIG. 9). Asa result, it is possible to achieve optimization of imaging noise and power consumption loss in accordance with exposure value setting at the time of shooting. In particular since ISO sensitivity information (S111 in FIG. 9), exposure compensation information (S115 in FIG. 9), shutter speed information (S119 in FIG. 9), and whether or not there is flash firing (S123 in FIG. 9) are elements that have an effect on the imaging noise, by considering these settings it is possible to further optimize imaging noise and power consumption loss.

Also, with the one embodiment and each of the modified examples of the present invention, operating mode is a setting relating to special effect processing after shooting (S141 in FIG. 11). As a result, it is possible to achieve optimization of imaging noise and power consumption loss in accordance with special effect processing setting. Since black-and-white processing, sepia tone processing and Diorama processing, as special effect processing, are processing that are not particularly affected by imaging noise, it is possible to optimize imaging noise and power consumption loss by taking the special effect processing into consideration.

Also, with the one embodiment and each of the modified examples of the present invention, operating mode is a setting relating to image storing after shooting (refer to FIG. 10). As a result, it is possible to achieve optimization of imaging noise and power consumption loss in accordance with image storage after shooting. Since settings of image size and compression rate, as image processing after shooting, are for processing that is not particularly susceptible to imaging noise, it is possible to optimize imaging noise and power consumption loss by taking these settings into consideration.

Also, with the one embodiment and each of the modified examples of the present invention, operating mode is a setting relating to a noise reduction effect at the time of long exposure shooting (S119 and S121 in FIG. 9). In the case of setting noise reduction mode at the time of long exposure shooting, when it is desired to minimize imaging noise it is possible to optimize imaging noise and power consumption loss by taking this setting into consideration.

Also, with the one embodiment and each of the modified examples of the present invention, operating mode is a setting relating to storage format (refer to FIG. 12). Permissible noise level differs between a still image and a movie, and generally a still image will have a lower permissible noise level. It is possible to optimize imaging noise and power consumption loss by taking this storage format setting into consideration.

Also, with the one embodiment and each of the modified examples of the present invention, operating mode is a setting relating to zoom range (refer to FIG. 13). Noise level differs with optical zoom and electronic zoom, and with electronic zoom trimming is carried out, which means that noise in the subject image will become high. It is possible to optimize imaging noise and power consumption loss by taking this zoom range setting into consideration.

Also, with the one embodiment and each of the modified examples of the present invention, operating mode is a setting relating to shooting mode (S143 in FIG. 11). As a result, it is possible to achieve optimization of imaging noise and power consumption loss in accordance with shooting mode settings. In particular, night scene mode, night scene with person mode, low key mode, candle mode and fireworks display mode are each intended for a dark subject, and it is likely there will be a lot of subject image noise. It is possible to optimize imaging noise and power consumption loss by taking at least one of these shooting modes into consideration.

With the one embodiment and each of the modified examples of the present invention, LDO regulators 29b-29f have been used as the constant voltage section. However, the constant voltage section is not limited to LDO regulators, and may be any constant voltage circuit having a characteristic such that output noise decreases with increase in input voltage.

Also, with the one embodiment and each of the modified examples of the present invention, description has focused on the fact that a constant voltage is supplied from the LDO regulator 22b to the CMOS image sensor 22, being an image sensor, but the present invention can be similarly applied to circuits and sensors in which noise is likely to be generated due to ambient temperature etc., such as the temperature sensor 23, WIFI communication section 51a, the sensor group 24 etc. Also, with the one embodiment and each of the modified examples of the present invention, supplementary illumination of the subject at the time of shooting is supplied using flash light of the flash firing section 16a, but this is not limiting, and similar effects can be achieved using high intensity white LEDs or electric bulbs etc.

Further, with this embodiment, a device for taking pictures has been described using a digital camera, but as a camera it is also possible to use a digital single lens reflex camera or a compact digital camera, or a camera for movie use such as a video camera, and further to have a camera that is incorporated into a mobile phone, a smart phone, a mobile information terminal (PDA: Personal Digital Assistant), game console etc. In any event, the present invention can be applied to a device that is susceptible to the occurrence of noise due to a power supply etc.

Also, regarding the operation flow in the patent claims, the specification and the drawings, for the sake of convenience description has been given using words representing sequence, such as “first” and “next”, but at places where it is not particularly described, this does not mean that implementation must be in this order.

The present invention is not limited to these embodiments, and structural elements may be modified in actual implementation within the scope of the gist of the embodiments. It is also possible form various inventions by suitably combining the plurality structural elements disclosed in the above described embodiments. For example, it is possible to omit some of the structural elements shown in the embodiments. It is also possible to suitably combine structural elements from different embodiments.

What is claimed is:

1. An imaging device, operated by power supplied from a main power supply, comprising:
an imaging section having an image sensor for forming a subject image and outputting image data;
a variable voltage conversion section, supplied with power from the main power supply, for converting to a designated voltage based on control signals, and outputting the designated voltage;
a constant voltage section that receives output of the variable voltage conversion section and supplies a constant voltage signal to the image sensor;
an input section for setting operating mode of the imaging device and
a control section for obtaining a voltage value input to the constant voltage section in accordance with operating mode that has been set by the input section, and designating an output voltage to the variable voltage conversion section.

2. The imaging device of claim 1, wherein:
the operating mode is a setting relating to exposure at the time of shooting.

3. The imaging device of claim 2, wherein:
setting relating to exposure at the time of shooting includes at least one of ISO sensitivity information, exposure compensation information, shutter speed information and whether or not a flash is fired.

4. The imaging device of claim 1, wherein:
the operating mode is a setting relating to special effect processing after shooting.

5. The imaging device of claim 4, wherein:
the setting relating to special effect processing after shooting includes at least one of black and white processing, sepia tone processing, and Diorama processing.

6. The imaging device of claim 1, wherein:
the operating mode is a setting relating to image storage after shooting.

7. The imaging device of claim 6, wherein:
the setting relating to image storage after shooting includes at least one of image size and image compression rate.

8. The imaging device of claim 1, wherein:
the operating mode is a setting relating to a noise reduction effect at the time of long exposure shooting.

9. The imaging device of claim 1, wherein:
the operating mode is a setting relating to storage format for a still image and a movie.

10. The imaging device of claim 1, wherein:
the operating mode is a setting relating to zoom range of an optical zoom and an electronic zoom.

11. An imaging method for an imaging device that is operated by supply of power from a main power supply, and has an imaging section including an image sensor for forming a subject image and outputting image data, comprising:
an output step of causing a variable voltage conversion section to convert a power supply from a main power supply to a designated voltage based on control signals, and output the designated voltage;
a supply step of receiving output of the variable voltage conversion section and causing a constant voltage section to supply a constant voltage signal to the image sensor;
a setting step of causing an input section to set operating mode of the imaging device; and
a designating step of calculating a voltage value input to the constant voltage section in accordance with operating mode that has been set by the input section, and designating an output voltage to the variable voltage conversion section.

12. A non-transitory computer-readable medium, storing a computer program for causing image processing to be executed by a computer of an imaging device that is operated by supply of power from a main power supply and has an imaging section including an image sensor for forming a subject image and outputting image data, the image processing comprising:
an output step of causing a variable voltage conversion section to convert a power supply from a main power supply to a designated voltage based on control signals, and output the designated voltage;
a supply step of receiving output of the variable voltage conversion section and causing a constant voltage section to supply a constant voltage signal to the image sensor;
a setting step of causing an input section to set operating mode of the imaging device; and
a designating step of calculating a voltage value input to the constant voltage section in accordance with operating mode that has been set by the input section, and designating an output voltage to the variable voltage conversion section.
